(19) United States
(12) Patent Application Publication
(10) Pub. No.: US 2008/0099159 A1
(43) Pub. Date: May 1, 2008

(54) Cordless window blind structure

(75) Inventor: Leslie Nien, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: DELILAH CO., LTD.

(21) Appl. No.: 11/543,981

(22) Filed: Oct. 6, 2006

(51) Int. Cl. E06B 9/30

(52) U.S. Cl. 160/170

(57) ABSTRACT

A cordless window blind structure comprises a blind body having a positioning cord mounted to both lateral sides respectively wherein the positioning cord is fixed to a head rail at one end. A bottom rail has both end sides drilled with a cord passage respectively and both sides of the bottom surface respectively equipped with a gliding element, and a clip element. The positioning cords mounted at both sides thereof and led through the cord passages can be respectively guided to run around the gliding element and firmly held in place by clip portions of the clip element. Moreover, cord-winding devices each having a torsion spring and a rotary member are fixed to the bottom surface of the bottom rail to which the positioning cords are attached at the bottommost ends. Therefore, the bottom rail and the windowsill can be accurately kept cordless to ensure the best application state thereby.

### BACKGROUND OF THE INVENTION

The present invention relates to a cordless window blind structure wherein a bottom rail has both end sides drilled with a cord passage thereon respectively and the bottom surface equipped with gliding elements, clip elements, and cord-winding devices to which positioning cords mounted at both sides of a blind body are sequentially wound and attached, and firmly held in place by clip portions of the clip elements; therefore, no matter a blind body is collected or expanded, the bottom rail and the windowsill can be accurately kept cordless there-between to ensure the best application state thereby.

Conventional window blinds on the market are usually made up of a roller gear set correspondingly working with lift cords and T-cords, which are rather complex and time-consuming in assembly. Besides, when the blind body thereof is collected upwards, the lift cords will suspend downwards, exposing outside for a certain length. As a result, children playing around can easily get caught in the dangling lift cords, and, if the children are not released immediately there-from or when the lift cords are unlocked to withdraw upwards, the suspending lift cords can accidentally strangle and hurt the children caught therein. Thus, the conventional window blind structure is quite unsafe in application and can cause danger to the family.

Referring to FIG. 1, another conventional window blind structure is disclosed in a Taiwan patent with the Publication No. M247689. The window blind includes a blind body 10 with a positioning cord 11 mounted to both left and right sides thereon respectively. The positioning cords 11 are fixed to a windowsill A at the bottommost ends thereof. A bottom rail 12 is equipped with a set of clip members 20 mounted to both end sides thereon. The clip member 20 is made up of a movable clip piece 21 and a fixed clip piece 22 that, each defined by a tooth-surfaced clip portion 211, 221, are flexibly bound together by a spring element to closely mesh to each other so as to firmly clamp the positioning cord 11 in place thereby. Therefore, the movable clip piece 21 of the clip member 20 is simply pushed inwards to compress the spring element and stretch open the clip portions 211, 221, permitting the positioning cord 11 to detach from the holding of the clip portions 211, 221 thereby. Then, the lower end of the bottom rail 12 can be guided along the positioning cords 11 so as to adjust the blind body 10 lifting or lowering to a desirable position. When the pressing force is removed from the movable clip piece 2, the clip portions 211, 221 thereof can rebound to mesh to each other and re-clamp the positioning cord 11 once again, stably relocating the blind body 10 in a collected or expanded position thereby. However, the positioning cords 11 are stretched straight to fix onto the windowsill A thereof. In application, the positioning cords 11 are still exposed between the bottom rail 12 and the windowsill A, which fail to provide a secure cordless space there-between. And the straight-extending positioning cords 11 can easily cause danger or hurt children with head and neck extending there-through. Thus, the above conventional blind structure still poses dangers to members in the household.

### SUMMARY OF THE PRESENT INVENTION

It is, therefore, the primary purpose of the present invention to provide a cordless window blind structure wherein a bottom rail has both end sides drilled with a cord passage respectively, and the bottom surface equipped with gliding elements, clip elements, and cord-winding devices to which positioning cords mounted at both sides of a blind body are sequentially wound and attached, and firmly held in place by clip portions of the clip elements. Therefore, no matter a blind body is collected upward or expanded downwards, the bottom rail and the windowsill can be accurately kept cordless there-between to ensure the best application state thereby.

### BRIEF DESCRIPTION OF THE DRAWINGS

FIG. 1 is a flat assembled view of a Taiwan Patent with the publication No. M247689.

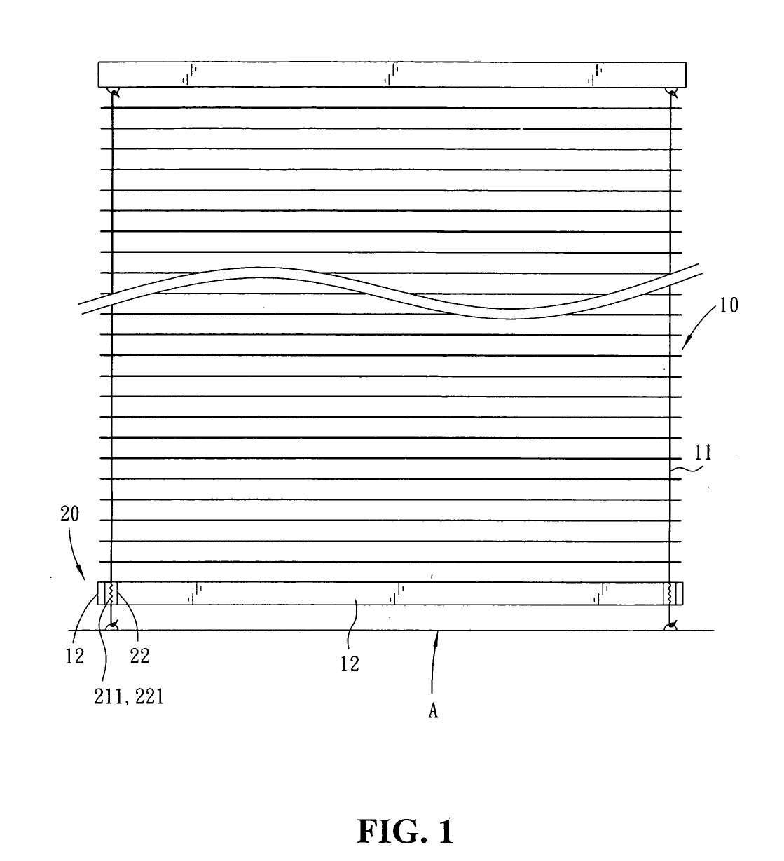

FIG. 2 is an assembled perspective view of the present invention.

FIG. 3 is an assembled cross sectional view of the present invention.

FIG. 4 is a partially enlarged and cross sectional view of the present invention as shown in FIG. 3.

FIG. 5 is a diagram showing a blind body of the present invention collected upwards in operation.

FIG. 6 is a diagram showing the blind body of the present invention positioned in a collected state.

FIG. 7 is an assembled cross sectional view of another embodiment of the present invention.

FIG. 8 is a partially enlarged and cross sectional view of another embodiment of the present invention.

FIG. 9 is a diagram showing a blind body of FIG. 7 collected upwards in operation.

FIG. 10 is a diagram showing the blind body of FIG. 7 positioned in a collected state.

### DETAILED DESCRIPTION OF THE PREFERRED EMBODIMENTS

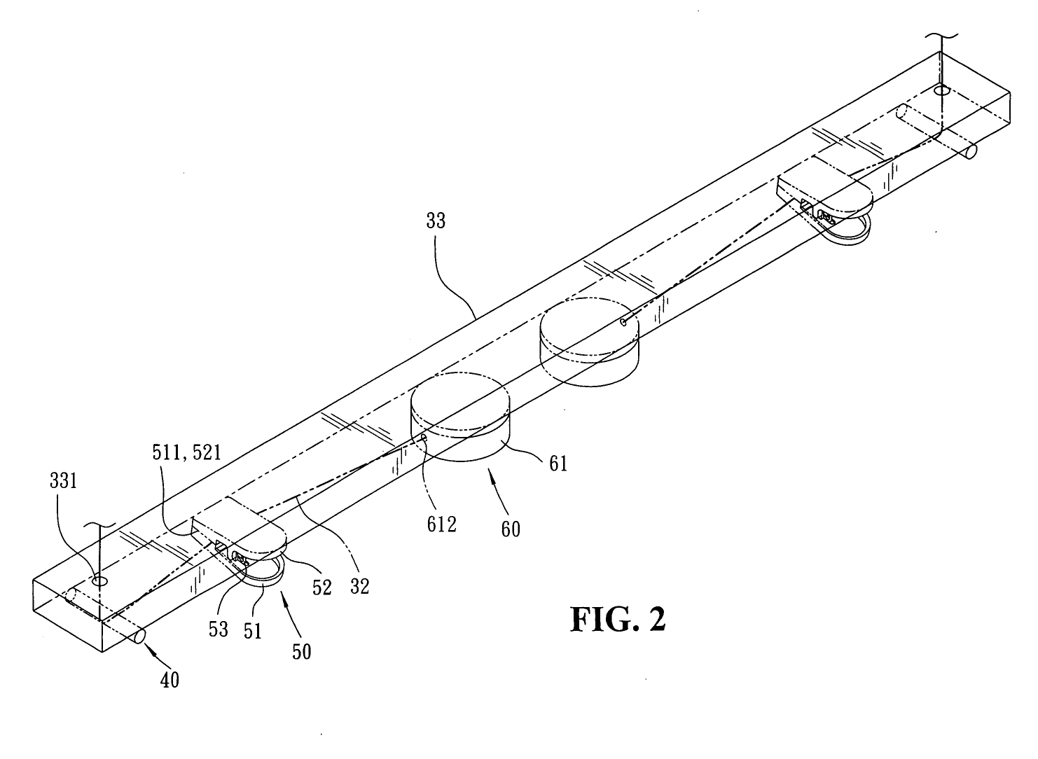

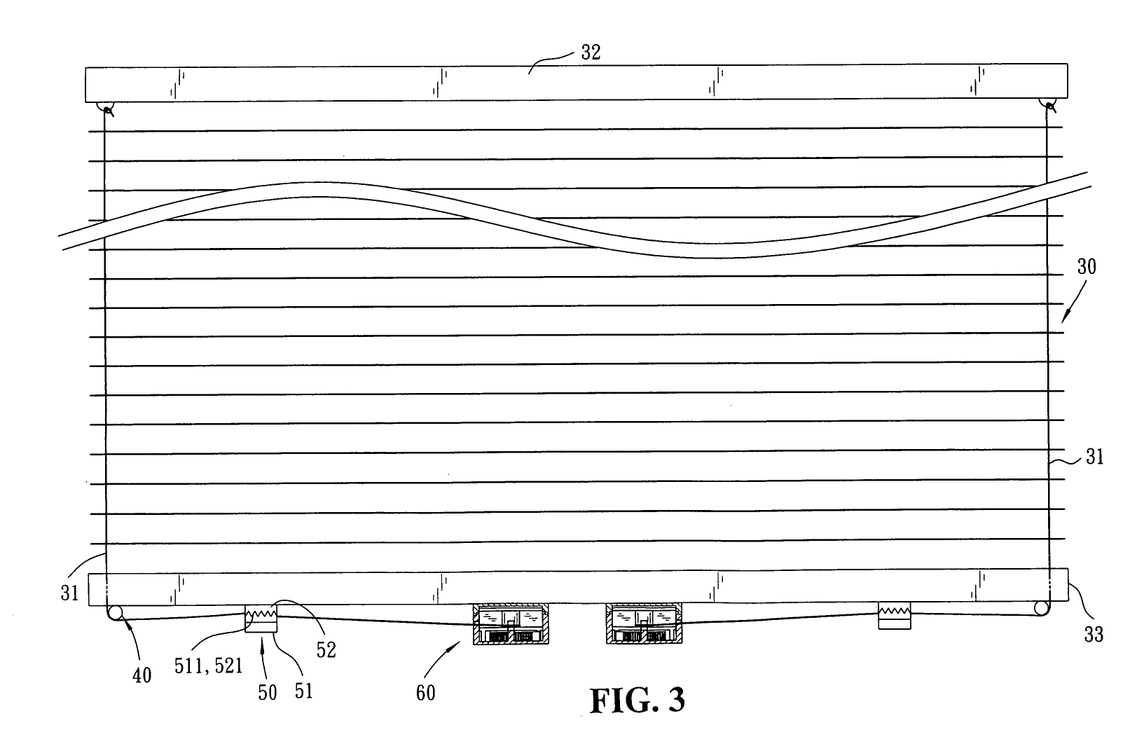

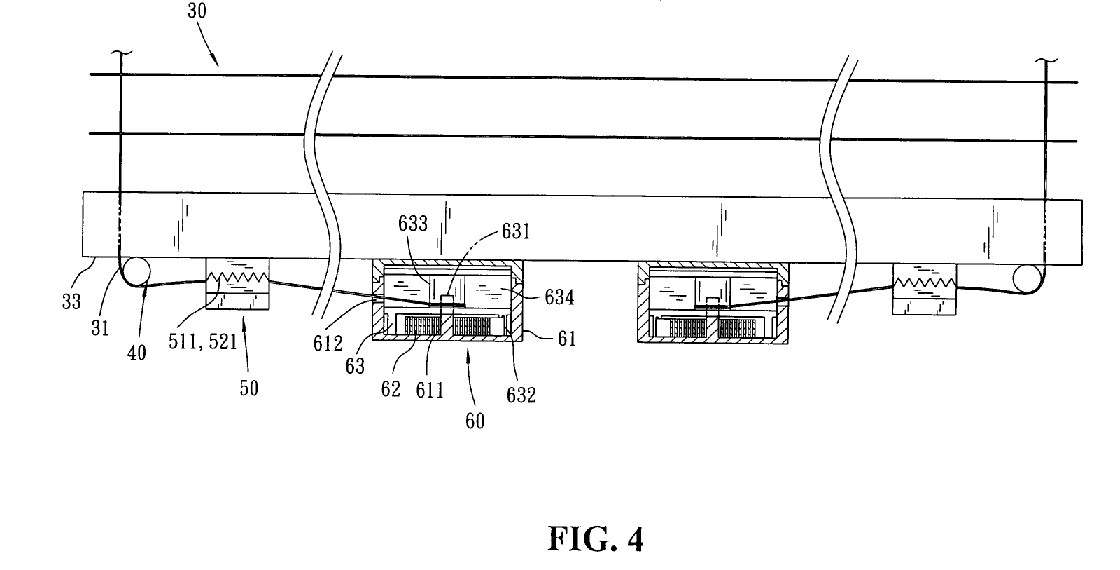

Please refer to FIG. 2 showing a perspective view of the present invention (accompanied by FIGS. 3, 4). The present invention relates to a cordless window blind structure, comprising a blind body 30 and a positioning cord 31 mounted to both left and right lateral sides of the blind body 30 thereon and fixed at one end to both end sides of a head rail 32 thereon respectively. A bottom rail 33 has both end sides drilled with a cord passage 331 thereon respectively, and both sides of the bottom surface respectively equipped with a gliding element 40, a clip element 50, and a cord-winding device 60 arranged in a sequence from each adjacent cord passage 331 towards the center thereon. The gliding element 40 is shaped in a cylindrical configuration, and the clip element 50 is made up of a movable clip piece 51 and a fixed clip piece 52 at both sides with a spring element 53 mounted there-between. The movable clip piece 51 and the fixed clip piece 51 of the clip element 50 are respectively equipped with a toothed clip portion 511, 521 defining the corresponding inner surface thereon, and both toothed clip portions 511, 521 thereof are elastically bound by the spring element 53 to closely mesh to each other thereby. The fixed clip piece 52 of the clip element 50 is fixedly attached to the bottom surface of the bottom rail 33 thereon. The cord-winding device 60 is made up of a housing 61 having a support shaft 611 disposed therein to which a torsion spring 62 and a rotary member 63 with a pivoting hole 631 are mounted. The torsion spring 62 has both ends respectively attached to the support shaft 611 and an insert groove 631 of the rotary member 63 thereof. And on top of the rotary member 63 is disposed a limiting groove 634 with a winding shaft 633 extending thereon. The housing 61 has one side equipped with a thru-hole 612 to communicate with the limiting groove 634 thereby. Thus, the positioning cords 31 mounted at both sides of the blind body 30 can be respectively guided to pass through the cord passages 331 of the bottom rail 33 to extend downwards. Then, each positioning cord 31 led to run along the gliding element 40 and extend through the clip element 50 is firmly clamped in place via the clip portions 511, 521 thereby. Finally, the end section of the positioning cord 31 is guided to thread through the thru-hole 612 of the cord-winding device 60 and securely attached to the winding shaft 633 thereon.

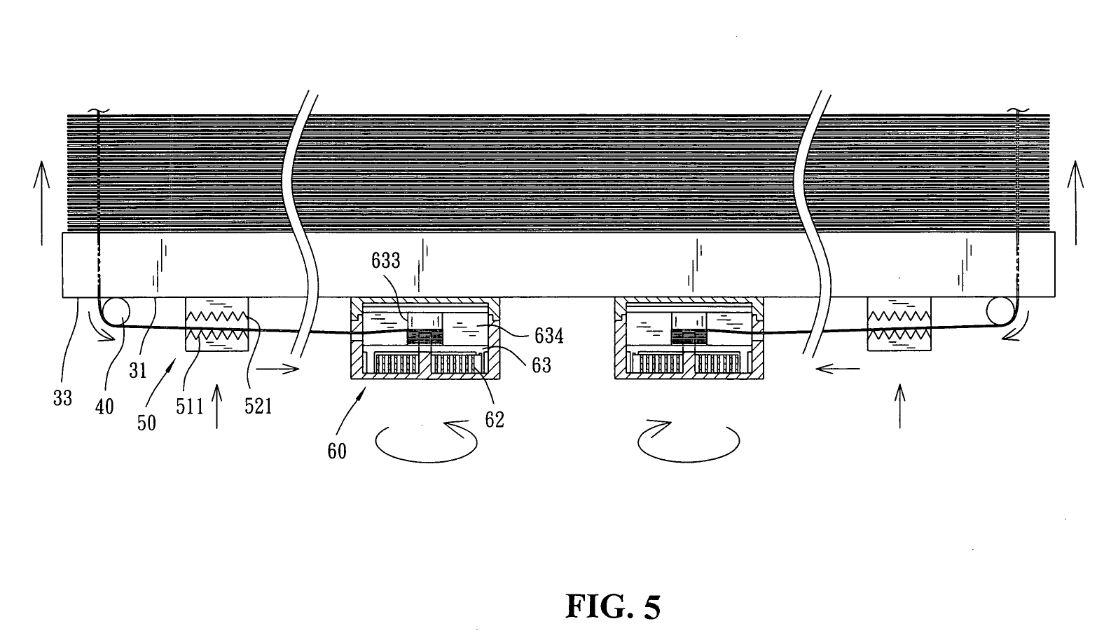

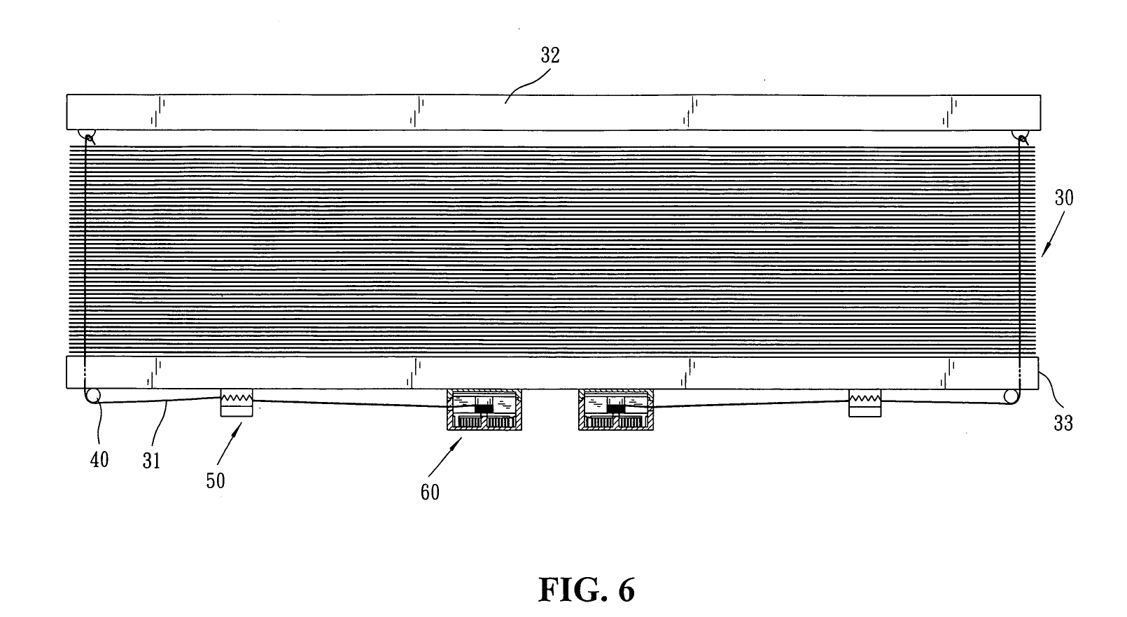

When the blind body 30 is expanded downwards, the torsion spring 62 accommodated in the cord-winding device 60 is kept in a densely coiled-up state and equipped with the flexibility of counter-winding thereof. When the blind body 30 is to be collected upward (referring to FIG. 5), the movable clip piece 51 of the clip element 50 is simply pushed so that the spring element 53 squeezed and compressed thereby can stretch open the clip portions 511, 521 and release the positioning cord 31 from the holding of the clip portions 511, 521 thereof. Thus, the bottom rail 33 can be pushed along the positioning cords 31 to lift upwards the blind body 30. Then, the positioning cord 31 is released in a loose state relative to the winding shaft 633, and the rotary member 63 free from the pulling force thereof will start revolving along with the counter-winding of the torsion spring 62 thereof. Thus, the positioning cord 31 will coil up along with the winding shaft 633 of the rotary element 63 to collect in the limiting groove 634 therein. When the pushing force exerted onto the movable clip piece 51 is removed, the clip portions 511, 521 will close up once again to mesh to each other and clip tight the positioning cord 31 thereby. Then, the rotary member 63 will stop spinning around, and the blind body 30 can be accurately located in a collected position thereby as shown in FIG. 6. Furthermore, when the blind body 30 is to be expanded downwards, the movable clip piece 51 is simply pressed to detach the positioning cord 31 from the clamping of the clip portions 511, 521 so that the bottom rail 33 can be moved along the positioning cord 31 to lower downwards the bind body 30 thereby. Meanwhile, the positioning cord 31 coiled onto the winding shaft 633 will be affected by the down-pulling force of the bottom rail 33 to actuate the rotary member 63 and the torsion springs 62 winding towards the other direction so as to release the positioning cord 31 thereby. When the pressing force exerted onto the movable clip piece 51 is removed, the clip portions 511, 521 will mesh up to each other once again to clamp tight the positioning cord 31 so that the rotary member 63 will stop spinning and the blind body 30 can be firmly located in an expanded position thereby. Therefore, no matter the blind body 30 is in a collected or an expanded state, the bottom rail 33 and the windowsill can be accurately kept cordless there-between to ensure the best application thereby.

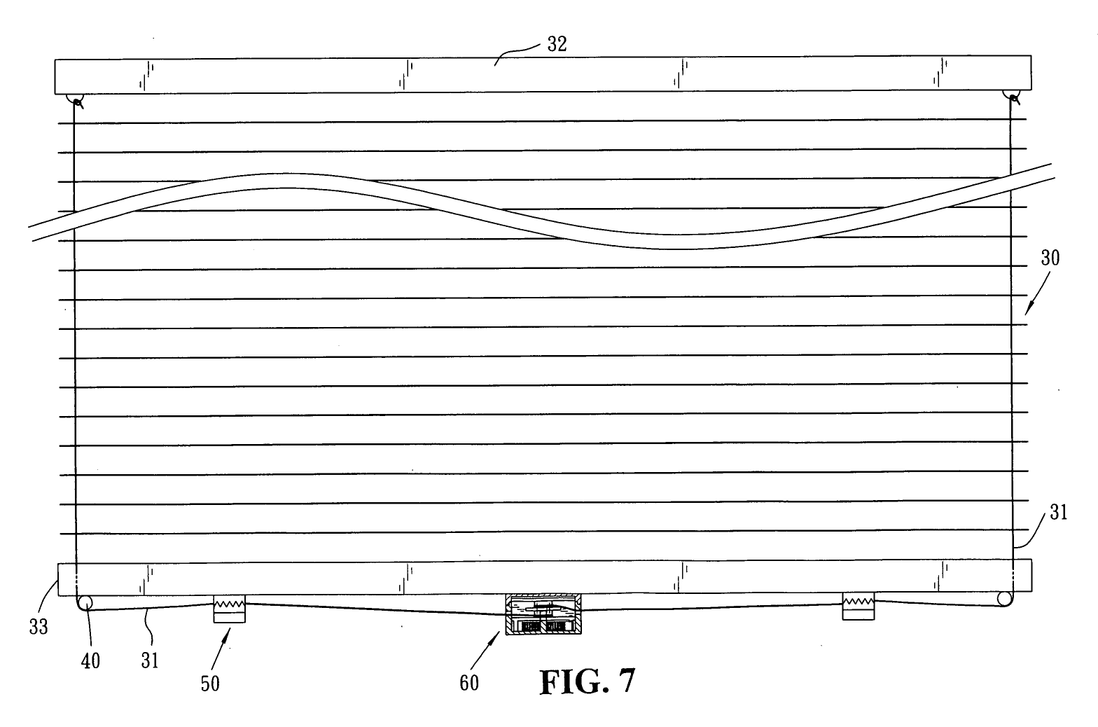

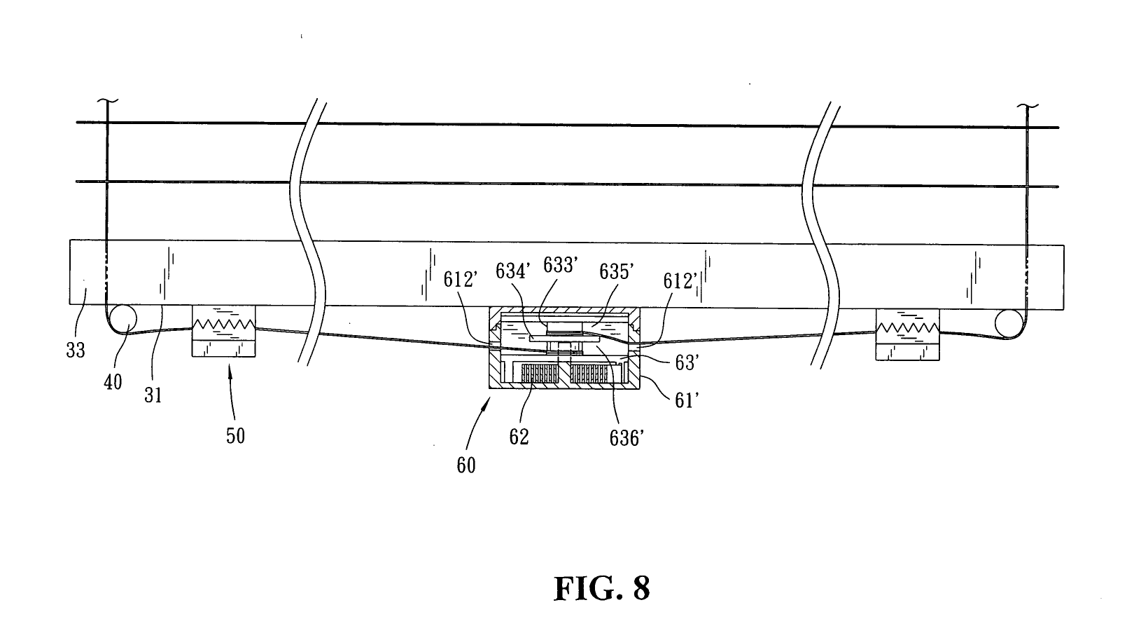

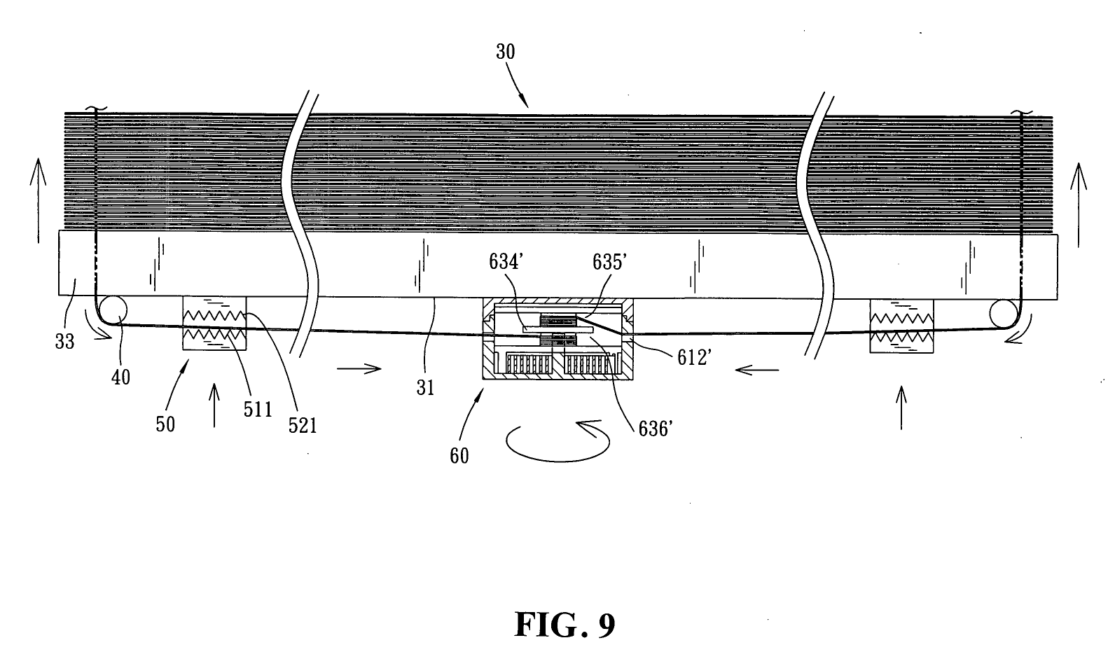

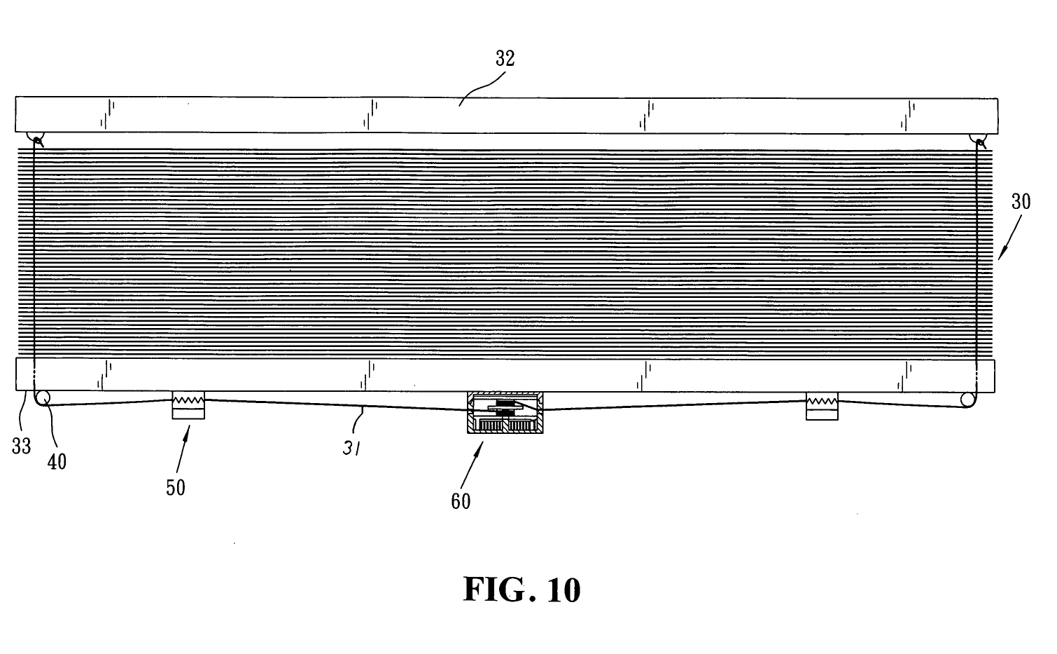

Please refer to FIGS. 7, 8. The bottom rail 33 can also have one cord-winding device 60 fixed to the middle section of the bottom surface thereon, and two sets of gliding elements 40 and clip elements 50 symmetrically arranged to both adjacent sides of the cord-winding device thereon. The cord-winding device 60 is equipped with a rotary member 63′ having a winding shaft 633′ divided by a separation board 634′ extending in the middle thereon to form a set of upper and lower limiting grooves 635′, 636′ thereby. Besides, the cord-winding device 61′ also includes a housing 61′ having a thru-hole 612′ disposed at both lateral sides thereon respectively for the extension of the positioning cords 31 there-through from both sides. The positioning cords 31 are respectively guided through the upper and lower limiting grooves 635′, 636′ to attach onto the winding shaft 633′ thereon. Therefore, when to collect (referring to FIG. 9) or to expand the blind body 30, the positioning cords 31 mounted at both sides thereof can run along with the revolving direction of the rotary member 63′ to synchronically coil up onto of the winding shaft 633′ of the upper and lower limiting grooves 635′, 636′ thereon or synchronically release there-from. Furthermore, the positioning cords 31 are firmly held in place by the clip elements 50 to locate in a desirable collected position as shown in FIG. 10 or in an expanded position thereby.

What is claimed is:

1. A cordless window blind structure, comprising a blind body, and a positioning cord mounted to both left and right sides of the blind body and fixed at one end to both sides of a head rail thereon respectively wherein a bottom rail has both end sides drilled with a cord passage thereon, and both sides of the bottom surface respectively equipped with a gliding element, and a clip element so that the positioning cords mounted at both sides of the blind body and led through the cord passages of the bottom rail are allowed to run around the gliding elements and extend through the clip elements to be firmly clamped in place by clip portions of the clip elements thereof; in addition, one or more than one of automatically-recoiling cord-winding devices are fixed to the bottom surface of the bottom rail to reciprocally work with the positioning cords thereby; therefore, the bottom rail and the windowsill can be accurately kept cordless there-between to ensure the best application state thereby.

2. The cordless window blind structure as claimed in claim 1 wherein the cord-winding device includes a housing having a support shaft to which a torsion spring and a rotary member equipped with a pivoting hole and an insert groove are mounted; the torsion spring has both ends respectively attached to the support shaft and the insert groove of the rotary member, and the rotary member also has a winding shaft mounted thereto for the attachment of the positioning cord thereby.

3. The cordless window blind structure as claimed in claim 2 wherein the cord-winding devices can be symmetrically fixed to both sides of the bottom middle section of the bottom rail, and the winding shaft of the rotary member has a limiting groove defining thereon to which a thru-hole disposed at one lateral side of the housing is connected, permitting the end sections of the positioning cords mounted at both sides of the blind body to respectively thread through the thru-hole of the cord-winding device and fixedly attach to the winding shaft thereon.

4. The cordless window blind structure as claimed in claim 2 wherein the cord-winding device can also be fixed to the bottom middle section of the bottom rail, and the winding shaft of the rotary member has a separation board extending in the middle thereon to divide a set of upper and lower limiting grooves thereby; besides, the housing has a thru-hole drilled at both lateral sides thereon respectively for the extension of the positioning cords there-through from both sides wherein the positioning cords are respectively guided through the upper and lower limiting grooves to attach onto the winding shaft thereby.

5. The cordless window blind structure as claimed in claim 1 wherein the gliding element is shaped in a cylindrical configuration.

6. The cordless window blind structure as claimed in claim 1 wherein the clip element is made up of a movable clip piece and a fixed clip piece at both sides thereof with a spring element mounted there-between, and the movable clip piece and the fixed clip piece of the clip element are respectively equipped with a toothed clip portion defining the corresponding inner surface thereon; both toothed clip portions are flexibly bound by the spring element to closely mesh to each other thereby, and the fixed clip piece of the clip element is firmly attached to the bottom surface of the bottom rail thereon.
